(19) United States
(12) Patent Application Publication
(10) Pub. No.: US 2014/0173521 A1
(43) Pub. Date: Jun. 19, 2014

(54) Shortcuts for Application Interfaces

(71) Applicant: APPLE INC., Cupertino, CA (US)

(72) Inventor: Robert Mayor, Half Moon Bay, CA (US)

(73) Assignee: APPLE INC., Cupertino, CA (US)

(21) Appl. No.: 13/717,199

(22) Filed: Dec. 17, 2012

(51) Int. Cl. G06F 3/0481

(52) U.S. Cl. CPC G06F 3/04817
USPC 715/835

(57) ABSTRACT

In some implementations, a shortcut can be created that allows a user to directly access a graphical user interface or subscreen of an application. The user can view an application user interface on a mobile device and provide input to cause a shortcut to be created for invoking the application user interface. In some implementations, the user can select an application user interface shortcut to invoke the application user interface or subscreen associated with the shortcut.

### TECHNICAL FIELD

The disclosure generally relates to invocation of software applications.

### BACKGROUND

Computing devices execute software applications to perform a variety of tasks. The software applications often have various user interfaces for performing different tasks. For example, an application can provide a user interface to allow the user to configure the settings of the application or the computing device. An application can provide a user interfaces for viewing different types or categories of media. Often a user will have to navigate through menus and make multiple inputs to view a desired application user interface. For example, the user may need to make multiple menu selections to view the settings user interface of an application. Requiring a user to make multiple menu selections to access a desired user interface can waste time and cause frustration for the user.

### SUMMARY

In some implementations, a shortcut can be created that allows a user to directly access a graphical user interface or subscreen of an application. The user can view an application user interface on a mobile device and provide input to cause a shortcut to be created for invoking the application user interface. In some implementations, the user can select an application user interface shortcut to invoke the application user interface or subscreen associated with the shortcut.

Particular implementations provide at least the following advantages: A user can create an application user interface shortcut for directly invoking or accessing an application user interface or subscreen while bypassing application user interfaces that would be initially displayed during a normal invocation of the application.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example graphical user interface for invoking applications on a mobile device.

FIG. 2 illustrates an example graphical user interface of an email application.

FIG. 3 illustrates an example graphical user interface of an email application.

FIG. 4 illustrates an example graphical user interface of an email application.

FIG. 5 illustrates an example graphical user interface for accessing a settings menu of an application or mobile device.

FIG. 6 illustrates an example graphical user interface for accessing a settings menu of an application or mobile device.

FIG. 7 illustrates an example graphical user interface for viewing usage statistics for a mobile device.

FIG. 8 illustrates an example graphical user interface for configuring a GUI shortcut.

FIG. 9 illustrates an example graphical user interface for invoking applications and GUI shortcuts on a mobile device.

FIG. 10A is flow diagram of an example process for creating a graphical user interface shortcut.

FIG. 10B is a flow diagram of an example process for invoking an application using a graphical user interface shortcut.

FIG. 11 is a block diagram of an exemplary system architecture implementing the features and processes of FIGS. 1-10B.

Like reference symbols in the various drawings indicate like elements.

### DETAILED DESCRIPTION

This disclosure describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radial buttons, checkboxes and any other mechanism for receiving input from, or providing feedback to a user.

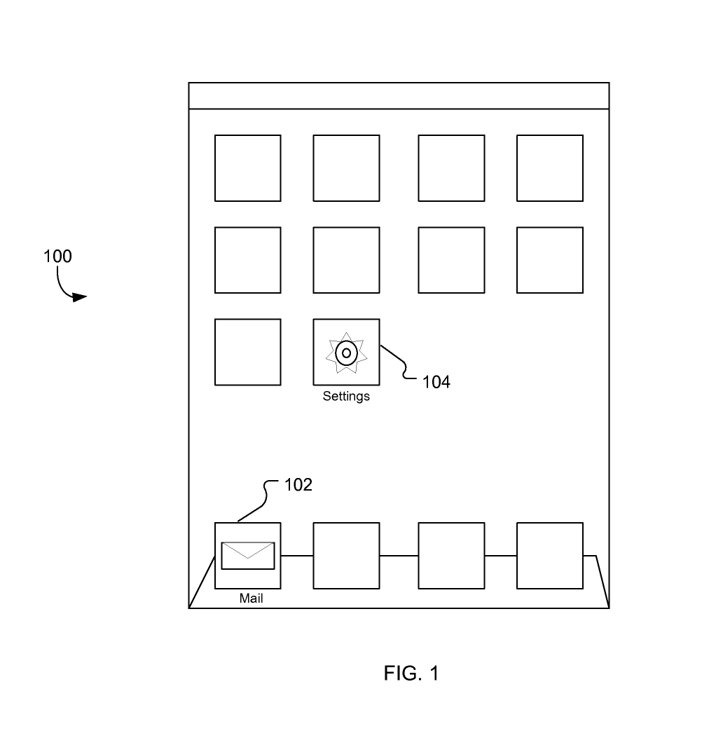

FIG. 1 illustrates an example graphical user interface 100 for invoking applications on a mobile device. For example, GUI 100 can be an interface of an operating system running on the mobile device. GUI 100 can be referred to herein as a home screen of the mobile device. In some implementations, GUI 100 can include graphical objects 102 and 104 for invoking respective applications. For example, graphical objects 102 and 104 can be icons or images that, when selected by a user, cause invocation of a corresponding application that is installed on the mobile device. Graphical object 102, for example, can be selected to invoke an email application on the mobile device. Graphical object 104 can be selected to invoke a settings application or function of the mobile device, for example.

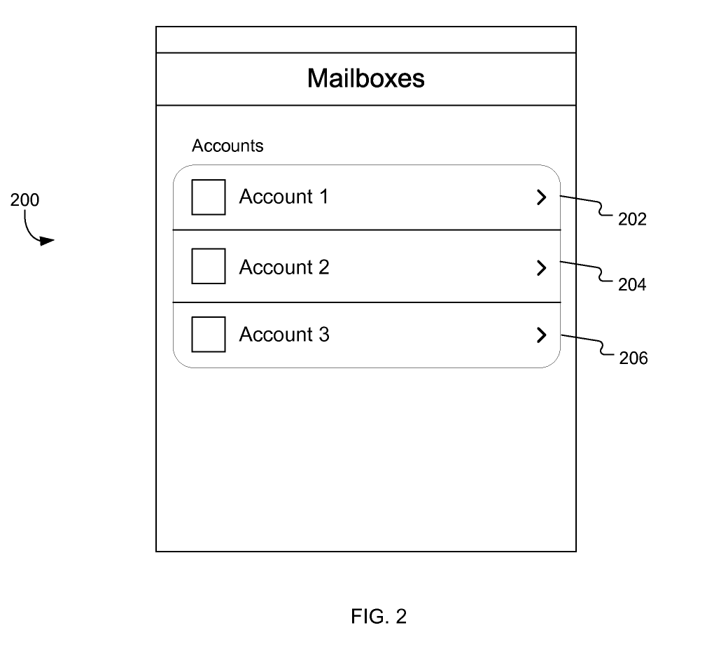

FIG. 2 illustrates an example graphical user interface 200 of an email application. For example, GUI 200 can be presented upon invocation of an email application. GUI 200 can be the first or initial GUI displayed when the email application is invoked in response to a user selecting graphical object 102, for example. GUI 200 can include graphical objects 202-206 for selecting an email account to present on the display of the mobile device. For example, users often have several email accounts with different email providers. The email application can be configured to present each of the user's email accounts on GUI 200. A user can select a graphical object 202, 204 or 206 to view email associated with the selected account. For example, the user can select graphical object 204 to view email associated with Account 2.

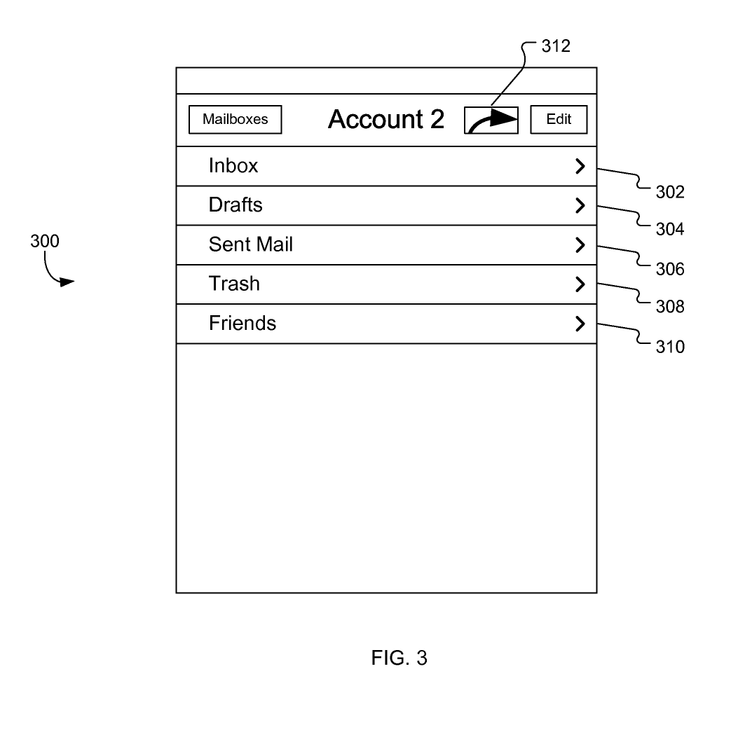

FIG. 3 illustrates an example graphical user interface 300 of an email application. For example, GUI 300 can be presented in response to the user selecting graphical object 204 of FIG. 2. GUI 300 can be referred to as a subscreen, subsequent screen or subsequent GUI of the email application since GUI 300 is invoked after or through GUI 200. GUI 300 can include graphical objects 302-310 corresponding to the email folders configured for Account 2. A user can select graphical object 310 to view email that has been placed into the ‘Friends” email folder, for example.

In some implementations, a user can select graphical object 312 to create a shortcut to GUI 300. For example, the user may wish to access email account ‘Account 2” directly from GUI 100. A user can create a shortcut on GUI 100 by selecting graphical object 312. When selected, the shortcut can cause GUI 300 to be immediately displayed upon invocation of the email application. Thus, the shortcut can allow the user to bypass displaying graphical user interfaces that would normally be displayed before GUI 300 (e.g., GUI 200).

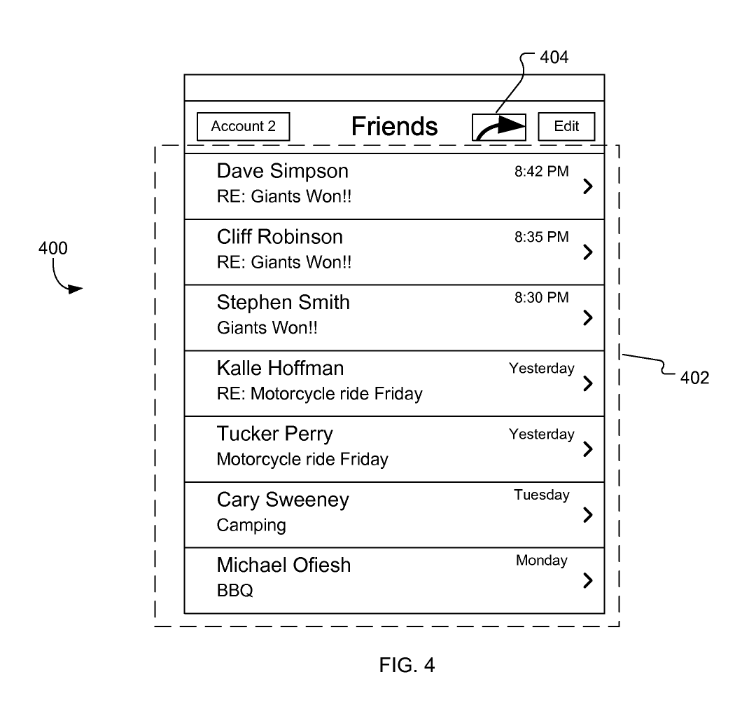

FIG. 4 illustrates an example graphical user interface 400 of an email application. For example, GUI 400 can be presented in response to the user selecting graphical object 310 of FIG. 3. GUI 400 can be referred to as a subscreen, subsequent screen or subsequent GUI of the email application since GUI 400 is invoked after or through GUI 300. GUI 400 can present emails 402 that are associated with the “Friends” folder, for example.

In some implementations, a user can select graphical object 404 to create a shortcut to GUI 400. For example, the user may wish to email in the “Friends” folder directly from GUI 100. A user can create a shortcut to GUI 400 on GUI 100 by selecting graphical object 404. When selected from GUI 100, the shortcut can cause GUI 400 to be immediately displayed upon invocation of the email application. Thus, the shortcut can allow the user to bypass displaying graphical user interfaces that would normally be displayed before invoking GUI 400 (e.g., GUI 200 and GUI 300).

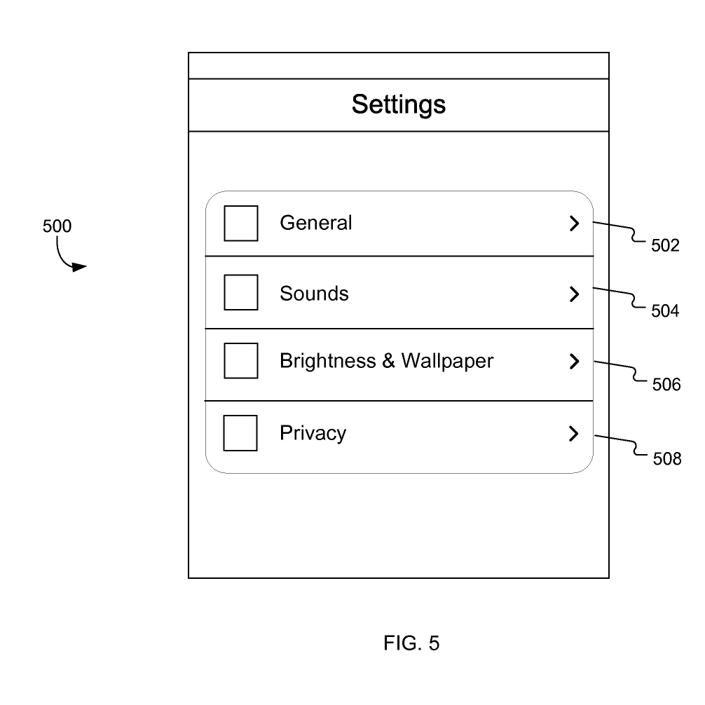

FIG. 5 illustrates an example graphical user interface 500 for accessing a settings menu of an application or mobile device. For example, GUI 500 can be invoked when the user selects graphical object 104 of FIG. 1. GUI 500 can be the initial (e.g., first) settings GUI displayed when graphical object 104 is selected. GUI 500 can include graphical objects 502-508 for accessing subscreens, submenus, or subsequent GUIs of the settings application or function invoked by selection of graphical object 104. For example, a user can select graphical object 502 to view the “General” settings category of the mobile device.

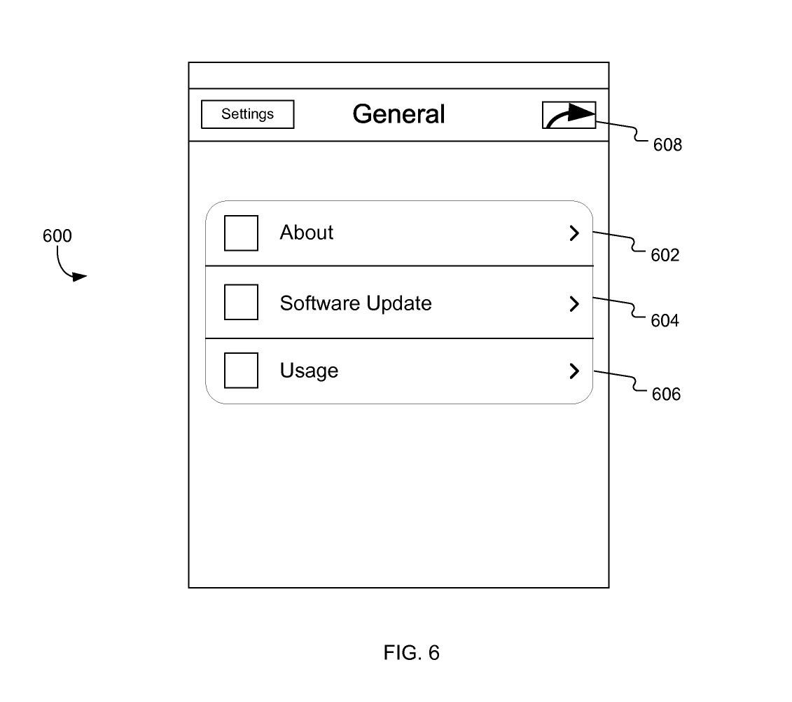

FIG. 6 illustrates an example graphical user interface 600 for accessing a settings menu of an application or mobile device. For example, GUI 600 can be invoked by selecting graphical object 502 of FIG. 5. GUI 600 can be a subscreen, submenu or subsequent GUI of a settings application or function, for example. GUI 600 can include graphical objects 602-606 for viewing general settings subsettings. For example, a user can select graphical object 606 to view usage statistics for the mobile device.

In some implementations, a user can select graphical object 608 to create a shortcut to GUI 600. For example, the user may wish to view “General” settings items directly from GUI 100. A user can create a shortcut to GUI 600 on GUI 100 by selecting graphical object 608. When selected from GUI 100, the shortcut can cause GUI 600 to be immediately displayed upon invocation of the settings application or function. Thus, the shortcut can allow the user to bypass displaying graphical user interfaces that would normally be displayed before invoking GUI 600 (e.g., GUI 500).

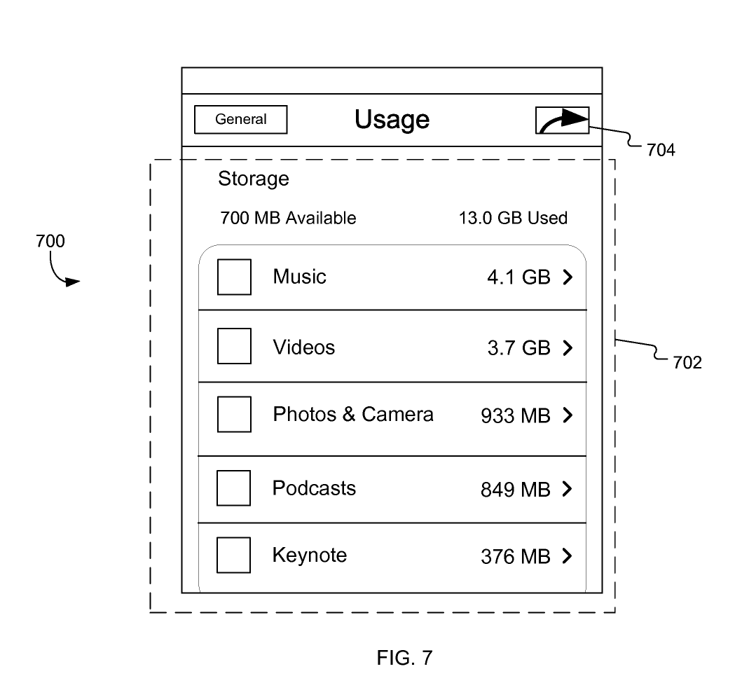

FIG. 7 illustrates an example graphical user interface 700 for viewing usage statistics for a mobile device. For example, GUI 700 can be invoked by a user selecting graphical object 606. GUI 700 can be a subscreen, submenu or subsequent GUI of a settings application or function, for example. GUI 700 can present usage statistics 702.

In some implementations, GUI 700 can include graphical object 704 for creating a shortcut to GUI 700. For example, the user may wish to view or access the usage statistics displayed on GUI 700 directly from GUI 100. A user can create a shortcut to GUI 700 on GUI 100 by selecting graphical object 704. When selected from GUI 100, the shortcut can cause GUI 700 to be immediately displayed upon invocation of the settings application or function. Thus, the shortcut can allow the user to bypass displaying graphical user interfaces that would normally be displayed before invoking GUI 700 (e.g., GUI 500 and GUI 600).

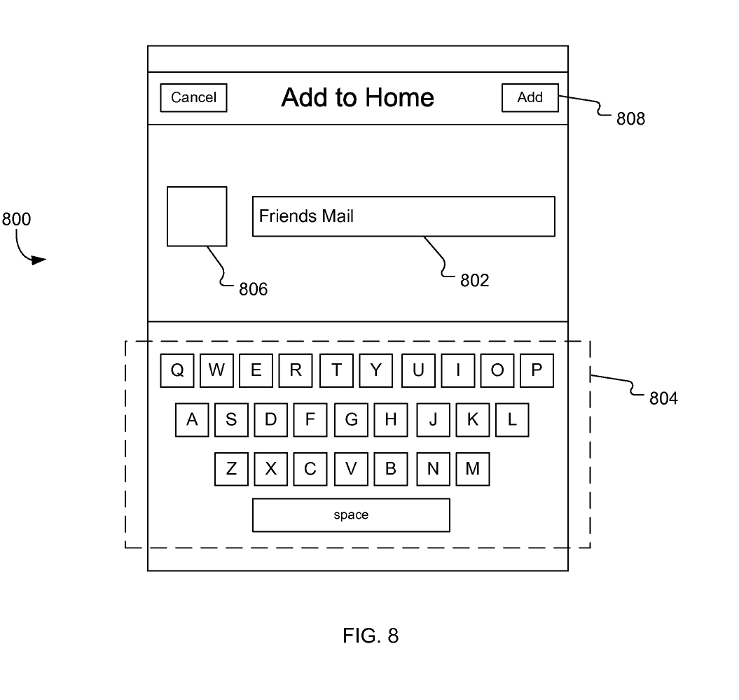

FIG. 8 illustrates an example graphical user interface 800 for configuring a GUI shortcut. For example, GUI 800 can be displayed in response to a user selecting graphical objects 312, 404, 608 and/or 704. GUI 800 can include text input box 802. A user can select text input box 802 and input (e.g., using virtual keyboard 804) a name for a GUI shortcut. For example, GUI 800 can be displayed in response to a user selecting (e.g., graphical object 608 of FIG. 6) to create a shortcut to GUI 600 for viewing email associated with the email folder “Friends,” as described above. The user can provide a name for the shortcut to GUI 600 by inputting the name (e.g., “Friends Mail”) into text box 802. GUI 800 can include graphical object (e.g. icon, image, etc.) 806 representing the “Friends Mail” shortcut. For example, graphical object 806 can be an icon or image representing or associated with GUI 800. Graphical object 806 can be an icon or image representing or associated with the email application. In some implementations, the GUI shortcut can be generated when the user selects graphical object 808. For example, when a user selects graphical object 808, the GUI shortcut can be generated and added to the home screen of the mobile device (e.g., GUI 100).

In some implementations, when the GUI shortcut is generated, the GUI shortcut can be associated with shortcut metadata. For example, the shortcut metadata can include information that identifies the application or function to be invoked, the GUI to display when the application or function is invoked, the name of the shortcut and the image or icon associated with the shortcut. For example, each GUI of an application or function can be associated with an identifier that the application or function can use to identify a particular GUI. In some implementations, the GUI identifier can be any unique identifier that the application or function can use to identify the particular GUI. For example, the application can maintain a mapping of GUI identifiers and application GUIs and the GUI identifier can be used to find a corresponding application GUI in the mapping.

In some implementations, the GUI identifier can indicate the GUI's relationship to other GUIs within the application or function. The GUI identifier can represent a path or hierarchy, for example. For example, a GUI identifier for the “Friends” email folder GUI can be “Mailboxes/Account 2/Friends” because a user would have to traverse the “Mailboxes” and “Account 2” GUIs in order to reach the “Friends” GUI of the email application, as described above.

By way of comparison, a GUI identifier can be distinguished from a uniform resource locator (URL), for example, in that a URL identifies content to be imported into an application and the GUI identifier can identify GUIs that are built into (e.g., compiled into) an application that is installed on the mobile device. For example, a URL identifies content external to a browser application, the browser application downloads the content identified by the URL and displays the content in a graphical user interface of the browser application. The URL does not identify a graphical user interface of the browser application (e.g., the browser executable).

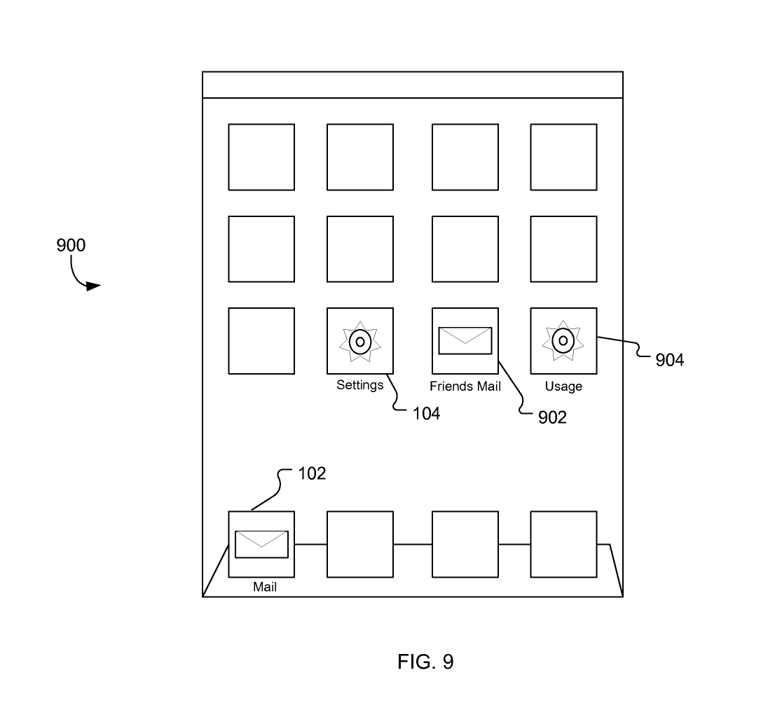

FIG. 9 illustrates an example graphical user interface 900 for invoking applications and GUI shortcuts on a mobile device. For example, graphical user interface 900 can correspond to graphical user interface 100 of FIG. 1. In some implementations, graphical user interface 900 can include GUI shortcut 902 and/or GUI shortcut 904. For example, GUI shortcut 902 can be selected to invoke GUI 400 (e.g., the “Friends” email folder) described above. In some implementations, GUI shortcut 902 can be created in response to a user selecting graphical object 404 of FIG. 4 and/or providing input to GUI 800, as described above. When GUI shortcut 902 is created, GUI shortcut 902 can be associated with GUI shortcut metadata (e.g., including application identifier and GUI identifier), as described above.

In some implementations, when GUI shortcut 902 is invoked (e.g., selected by a user), the application identifier can be used by the mobile device to invoke the application. The GUI identifier can be passed as a parameter to the application. The application can use the GUI identifier to determine which application GUI to display first. For example, the application can store information mapping GUI identifiers to respective application GUIs. When a GUI identifier is received as a parameter when the application is invoked, the application can determine which application GUI to display first by looking up the GUI identifier in the GUI mapping and displaying the corresponding application GUI. Thus, when GUI shortcut 902 is invoked, the mail application can be invoked with a GUI identifier (e.g., “Mailboxes/Account 2/Friends,” “Friends,” or unique ID) identifying GUI 400 as a parameter. Once the application is initialized and running on the mobile device, the mail application can display GUI 400 before other GUIs of the mail application.

Similarly, GUI shortcut 904 can be selected to invoke GUI 700 (e.g., the “Usage” statistics interface) described above. When GUI shortcut 904 is selected, the mobile device can invoke the “Settings” application or function and pass a GUI identifier corresponding to GUI 700 as a parameter to the invocation of the “Settings” application or function. The “Settings” application or function can use the GUI identifier to determine which GUI to display first. The “Settings” application or function can then display the “Usage” statistics GUI 700 without requiring the user to first traverse or view other user interfaces of the “Settings” application or function.

### Example Processes

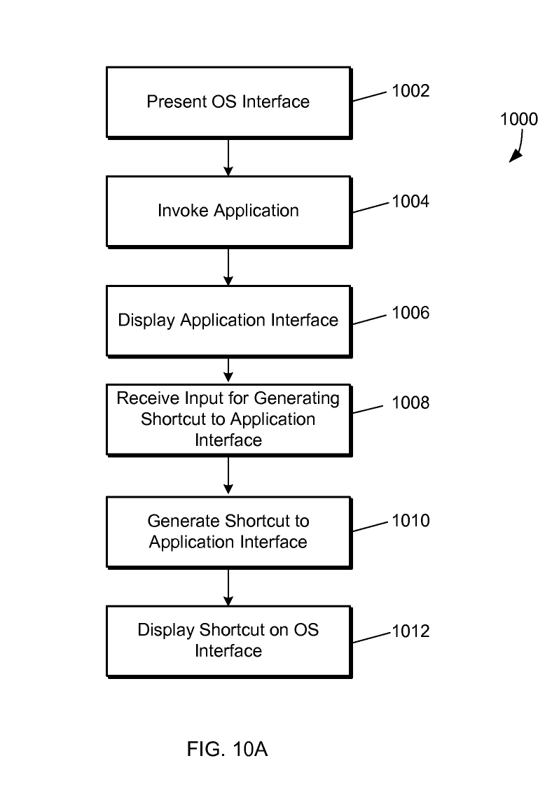

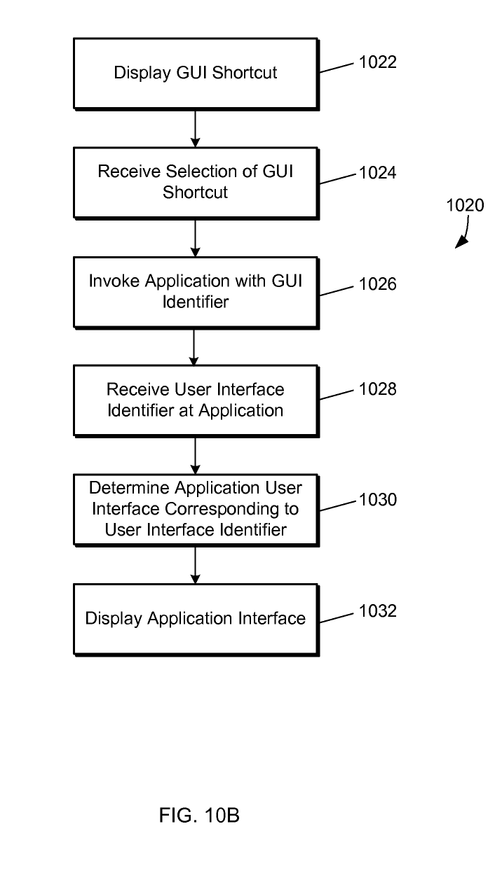

FIG. 10A is flow diagram of an example process 1000 for creating a graphical user interface shortcut. For example, process 1000 allows a user to create a shortcut that when selected invokes a specific graphical user interface of an application or function of a mobile device.

At step, 1002 an operating system interface can be presented on the mobile device. For example, a desktop or home screen interface can be presented on a display of the mobile device. The desktop or home screen interface can present icons or other graphical objects that when selected can invoke applications stored on the mobile device. The operating system interface can correspond to the interface 100 of FIG. 1, for example.

At step 1004, an application can be invoked. For example, the user can select an icon displayed on graphical user interface 100 to invoke an application stored on the mobile device.

At step 1006, an application graphical user interface can be displayed. For example, when the application is invoked, the application can present an initial application graphical user interface. In some implementations, the user can select menu items, buttons or other user interface elements of the application to navigate to and display various subsequent graphical user interfaces. For example, graphical user interfaces corresponding to various application subscreens, menus, options panels, etc. can be presented on the display of the mobile device, such as graphical user interfaces 300, 400, 600 and/or 700 of FIGS. 3, 4, 6 and 7.

At step 1008, input can be received for generating a shortcut to an application graphical user interface. For example, once the user has navigated to a graphical user interface (e.g., subscreen, subsequent GUI, etc.) of the application, the user can select a button, menu item or other graphical object to indicate to the application that a shortcut to the currently displayed application graphical user interface should be generated.

At step 1010, a shortcut to an application graphical user interface can be generated. For example, in response to the input received at step 1008, the application can present graphical user interface 800 of FIG. 8 to allow the user to specify a name for the GUI shortcut. The application can then invoke an application programming interface (API) of the mobile device's operating system to generate a shortcut to the currently displayed application graphical user interface. For example, the application can provide an image, a name, a GUI identifier corresponding to the application GUI to invoke and/or an identifier for the application (e.g., the location and name of the application executable file). The operating system can use the image, name, GUI identifier and/or application identifier to generate an icon that when selected by a user will invoke the application GUI. For example, an icon can be generated based on the image and associated with the name, GUI identifier and/or application identifier.

At step 1012, the GUI shortcut can be displayed on the operating system graphical user interface. For example, the icon can be presented on the operating system GUI (e.g., desktop, home screen, etc.), as described with reference to GUI 900 of FIG. 9.

FIG. 10B is a flow diagram of an example process 1020 for invoking an application using a graphical user interface shortcut. For example, a user can select an icon displayed on a mobile device to invoke a specific application graphical user interface, subscreen, menu panel, options screen, etc. without having to navigate through initial or preliminary application graphical user interfaces. For example, if an application is normally configured to display a particular GUI first upon invocation of the application, the GUI shortcut can cause the application to display a GUI that is different than the particular GUI when invoked.

At step 1022, a graphical user interface shortcut can be displayed. For example, the GUI shortcut can be displayed on an operating system interface (e.g., desktop, home screen, etc.) of a mobile device. For example, the GUI shortcut can be displayed on GUI 100 and/or GUI 900 described with reference to FIGS. 1 and 9. At step 1024, a selection of the GUI shortcut can be received. For example, a user can select the GUI shortcut displayed at step 1022.

At step 1026, an application can be invoked with a GUI identifier. For example, when the GUI shortcut is selected, the mobile device can use the application identifier and the GUI identifier associated with the GUI shortcut to invoke the application. The mobile device can pass the GUI identifier to the application during invocation of the application as a parameter or option, for example.

At step 1028, the application can receive the GUI identifier. For example, the GUI identifier can be received as an invocation parameter or option for the application.

At step 1030, the application can determine the application user interface corresponding to the GUI identifier. In some implementations, the application can include, store and/or maintain application data that maps GUI identifiers to respective graphical user interfaces of the application. The application can determine which application GUI to display based on the mapping and the received GUI identifier. For example, the GUI identifier can be compared to the GUI identifiers in the mapping to determine the application GUI corresponding to the GUI identifier.

In some implementations, the application can use the GUI identifier to internally navigate to a graphical user interface. For example, if the GUI identifier includes a path (e.g., “Mailboxes/Account 2/Friends”) to the GUI identified by the GUI identifier, then the application can use the GUI identifier to traverse the application graphical user interfaces included in the path. For example, the application can internally navigate (e.g., without displaying the GUIs) the path “Mailboxes/Account 2/Friends” from the “Mailbox” GUI, to the “Account 2” GUI and to the “Friends” GUI of the email application described above. Once the end of the path has been reached (e.g., the “Friends” GUI), the GUI identified at the end of the path can be displayed. For example, a GUI identifier that specifies a path can be useful when application GUIs are generated dynamically and cannot be identified in a predefined mapping.

At step 1032, the identified application graphical user interface can be displayed. For example, once the application has determined an application GUI that corresponds to the received GUI identifier, the application can display the corresponding application GUI. For example, the identified application GUI can be the first application GUI displayed by the application.

### Example System Architecture

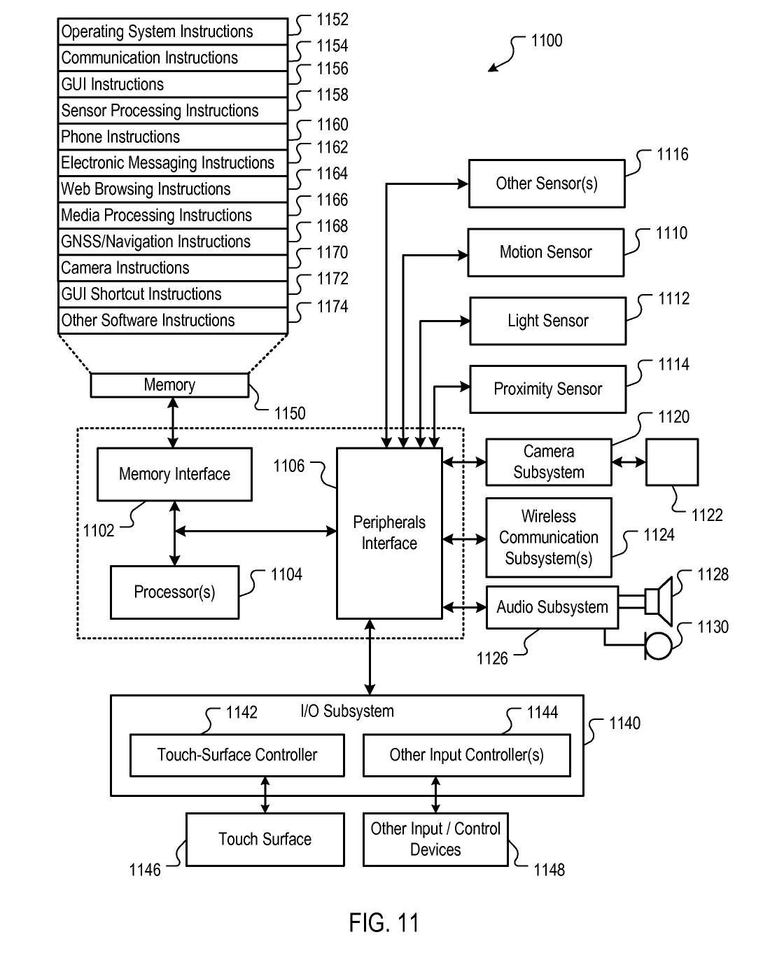

FIG. 11 is a block diagram of an example computing device 1100 that can implement the features and processes of FIGS. 1-10B. For example, computing device 1100 can be the mobile device described above. The computing device 1100 can include a memory interface 1102, one or more data processors, image processors and/or central processing units 1104, and a peripherals interface 1106. The memory interface 1102, the one or more processors 1104 and/or the peripherals interface 1106 can be separate components or can be integrated in one or more integrated circuits. The various components in the computing device 1100 can be coupled by one or more communication buses or signal lines.

Sensors, devices, and subsystems can be coupled to the peripherals interface 1106 to facilitate multiple functionalities. For example, a motion sensor 1110, a light sensor 1112, and a proximity sensor 1114 can be coupled to the peripherals interface 1106 to facilitate orientation, lighting, and proximity functions. Other sensors 1116 can also be connected to the peripherals interface 1106, such as a global navigation satellite system (GNSS) (e.g., GPS receiver), a temperature sensor, a biometric sensor, magnetometer or other sensing device, to facilitate related functionalities.

A camera subsystem 1120 and an optical sensor 1122, e.g., a charged coupled device (CCD) or a complementary metal-oxide semiconductor (CMOS) optical sensor, can be utilized to facilitate camera functions, such as recording photographs and video clips. The camera subsystem 1120 and the optical sensor 1122 can be used to collect images of a user to be used during authentication of a user, e.g., by performing facial recognition analysis.

Communication functions can be facilitated through one or more wireless communication subsystems 1124, which can include radio frequency receivers and transmitters and/or optical (e.g., infrared) receivers and transmitters. The specific design and implementation of the communication subsystem 1124 can depend on the communication network(s) over which the computing device 1100 is intended to operate. For example, the computing device 1100 can include communication subsystems 1124 designed to operate over a GSM network, a GPRS network, an EDGE network, a Wi-Fi or WiMax network, and a Bluetooth™ network. In particular, the wireless communication subsystems 1124 can include hosting protocols such that the device 100 can be configured as a base station for other wireless devices.

An audio subsystem 1126 can be coupled to a speaker 1128 and a microphone 1130 to facilitate voice-enabled functions, such as speaker recognition, voice replication, digital recording, and telephony functions. The audio subsystem 1126 can be configured to facilitate processing voice commands, voiceprinting and voice authentication, for example.

The I/O subsystem 1140 can include a touch-surface controller 1142 and/or other input controller(s) 1144. The touch-surface controller 1142 can be coupled to a touch surface 1146. The touch surface 1146 and touch-surface controller 1142 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1146.

The other input controller(s) 1144 can be coupled to other input/control devices 1148, such as one or more buttons, rocker switches, thumb-wheel, infrared port, USB port, and/or a pointer device such as a stylus. The one or more buttons (not shown) can include an up/down button for volume control of the speaker 1128 and/or the microphone 1130.

In one implementation, a pressing of the button for a first duration can disengage a lock of the touch surface 1146; and a pressing of the button for a second duration that is longer than the first duration can turn power to the computing device 1100 on or off. Pressing the button for a third duration can activate a voice control, or voice command, module that enables the user to speak commands into the microphone 1130 to cause the device to execute the spoken command. The user can customize a functionality of one or more of the buttons. The touch surface 1146 can, for example, also be used to implement virtual or soft buttons and/or a keyboard.

In some implementations, the computing device 1100 can present recorded audio and/or video files, such as MP3, AAC, and MPEG files. In some implementations, the computing device 1100 can include the functionality of an MP3 player, such as an iPod™. The computing device 1100 can, therefore, include a 36-pin connector that is compatible with the iPod. Other input/output and control devices can also be used.

The memory interface 1102 can be coupled to memory 1150. The memory 1150 can include high-speed random access memory and/or non-volatile memory, such as one or more magnetic disk storage devices, one or more optical storage devices, and/or flash memory (e.g., NAND, NOR). The memory 1150 can store an operating system 1152, such as Darwin, RTXC, LINUX, UNIX, OS X, WINDOWS, or an embedded operating system such as VxWorks.

The operating system 1152 can include instructions for handling basic system services and for performing hardware dependent tasks. In some implementations, the operating system 1152 can be a kernel (e.g., UNIX kernel). In some implementations, the operating system 1152 can include instructions for performing voice authentication. For example, operating system 1152 can implement the graphical user interface shortcut features as described with reference to FIGS. 1-10B.

The memory 1150 can also store communication instructions 1154 to facilitate communicating with one or more additional devices, one or more computers and/or one or more servers. The memory 1150 can include graphical user interface instructions 1156 to facilitate graphic user interface processing; sensor processing instructions 1158 to facilitate sensor-related processing and functions; phone instructions 1160 to facilitate phone-related processes and functions; electronic messaging instructions 1162 to facilitate electronic-messaging related processes and functions; web browsing instructions 1164 to facilitate web browsing-related processes and functions; media processing instructions 1166 to facilitate media processing-related processes and functions; GNSS/Navigation instructions 1168 to facilitate GNSS and navigation-related processes and instructions; and/or camera instructions 1170 to facilitate camera-related processes and functions.

The memory 1150 can store software instructions 1172 to facilitate processes and functions, such as the graphical user interface shortcut processes and functions as described with reference to FIGS. 1-10B.

The memory 1150 can also store other software instructions 1174, such as web video instructions to facilitate web video-related processes and functions; and/or web shopping instructions to facilitate web shopping-related processes and functions. In some implementations, the media processing instructions 1166 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 1150 can include additional instructions or fewer instructions. Furthermore, various functions of the computing device 1100 can be implemented in hardware and/or in software, including in one or more signal processing and/or application specific integrated circuits.

What is claimed is:

1. A method comprising:
presenting an initial graphical user interface of an application on a display of a mobile device;
after presenting the initial graphical user interface, presenting a subsequent graphical user interface of the application on the display;
receiving input from a user;
in response to the input, generating a shortcut to the subsequent graphical user interface, where the mobile device is configured to display the subsequent graphical user interface when the shortcut is selected; and
displaying the shortcut on an operating system graphical user interface of the mobile device.

2. The method of claim 1, further comprising:
determining an identifier corresponding to the subsequent graphical user interface; and
associating the identifier with the shortcut.

3. The method of claim 1, further comprising:
receiving a selection of the shortcut displayed on the operating system graphical user interface, the shortcut associated with an identifier that identifies the subsequent graphical user interface of the application;
invoking the application, the invocation including the identifier as a parameter to the invocation;
presenting the subsequent graphical user interface before any other graphical user interface of the application.

4. The method of claim 3, wherein presenting the subsequent graphical user interface before any other graphical user interface of the application comprises:
receiving by the application the identifier;
determining, by the application, that the subsequent graphical user interface corresponds to the identifier; and
presenting the subsequent graphical user interface on the mobile device.

5. The method of claim 4, further comprising:
maintaining, by the application, a mapping of identifiers to graphical user interfaces of the application; and
determining, by the application, that the subsequent graphical user interface corresponds to the identifier based on the identifier and the mapping.

6. The method of claim 1, wherein the subsequent graphical interface is built into the application.

7. The method of claim 1, wherein the operating system graphical user interface is a home screen or desktop interface of the mobile device.

8. A non-transitory computer-readable medium including one or more sequences of instructions which, when executed by one or more processors, causes:
presenting an initial graphical user interface of an application on a display of a mobile device;
after presenting the initial graphical user interface, presenting a subsequent graphical user interface of the application on the display;
receiving input from a user;
in response to the input, generating a shortcut to the subsequent graphical user interface, where the mobile device is configured to display the subsequent graphical user interface when the shortcut is selected; and
displaying the shortcut on an operating system graphical user interface of the mobile device.

9. The non-transitory computer-readable medium of claim 8, wherein the instructions cause:
determining an identifier corresponding to the subsequent graphical user interface; and
associating the identifier with the shortcut.

10. The non-transitory computer-readable medium of claim 8, wherein the instructions cause:
receiving a selection of the shortcut displayed on the operating system graphical user interface, the shortcut associated with an identifier that identifies the subsequent graphical user interface of the application;
invoking the application, the invocation including the identifier as a parameter to the invocation;
presenting the subsequent graphical user interface before any other graphical user interface of the application.

11. The non-transitory computer-readable medium of claim 10, wherein the instructions that cause presenting the subsequent graphical user interface before any other graphical user interface of the application comprise instructions that cause:
receiving by the application the identifier;
determining, by the application, that the subsequent graphical user interface corresponds to the identifier; and
presenting the subsequent graphical user interface on the mobile device.

12. The non-transitory computer-readable medium of claim 11, wherein the instructions cause:
maintaining, by the application, a mapping of identifiers to graphical user interfaces of the application; and
determining, by the application, that the subsequent graphical user interface corresponds to the identifier based on the identifier and the mapping.

13. The non-transitory computer-readable medium of claim 8, wherein the subsequent graphical interface is built into the application.

14. The non-transitory computer-readable medium of claim 8, wherein the operating system graphical user interface is a home screen or desktop interface of the mobile device.

15. A system comprising:
one or more processors; and
a non-transitory computer-readable medium including one or more sequences of instructions which, when executed by the one or more processors, causes:
presenting an initial graphical user interface of an application on a display of a mobile device;
after presenting the initial graphical user interface, presenting a subsequent graphical user interface of the application on the display;
receiving input from a user;
in response to the input, generating a shortcut to the subsequent graphical user interface, where the mobile device is configured to display the subsequent graphical user interface when the shortcut is selected; and
displaying the shortcut on an operating system graphical user interface of the mobile device.

16. The system of claim 15, wherein the instructions cause:
determining an identifier corresponding to the subsequent graphical user interface; and
associating the identifier with the shortcut.

17. The system of claim 15, wherein the instructions cause:
receiving a selection of the shortcut displayed on the operating system graphical user interface, the shortcut associated with an identifier that identifies the subsequent graphical user interface of the application;
invoking the application, the invocation including the identifier as a parameter to the invocation;
presenting the subsequent graphical user interface before any other graphical user interface of the application.

18. The system of claim 17, wherein the instructions that cause presenting the subsequent graphical user interface before any other graphical user interface of the application comprise instructions that cause:
receiving by the application the identifier;
determining, by the application, that the subsequent graphical user interface corresponds to the identifier; and
presenting the subsequent graphical user interface on the mobile device.

19. The system of claim 18, wherein the instructions cause:
maintaining, by the application, a mapping of identifiers to graphical user interfaces of the application; and
determining, by the application, that the subsequent graphical user interface corresponds to the identifier based on the identifier and the mapping.

20. The system of claim 15, wherein the subsequent graphical interface is built into the application.

21. The system of claim 15, wherein the operating system graphical user interface is a home screen or desktop interface of the mobile device.
